(19) United States
(12) Patent Application Publication
(10) Pub. No.: US 2026/0037503 A1
(43) Pub. Date: Feb. 5, 2026

(54) SYSTEMS AND METHODS FOR ATTRIBUTE EXTRACTION USING GENERATIVE ARTIFICIAL INTELLIGENCE

(71) Applicant: Walmart Apollo, LLC, Bentonville, AR (US)

(72) Inventors: Ankur Vivek Singh, Bengaluru (IN); Jitesh Chandra Mishra, Bengaluru (IN); Arun Menon, Varthur (IN); Samrat Kokkula, Dallas, TX (US); Ajinkya Ajay More, Santa Clara, CA (US); Arup Kumar Das, Bengaluru (IN); Prashanth Rao R V, Bangalore (IN); Nitish Ranjan Sahoo, Bengaluru (IN)

(21) Appl. No.: 19/228,543

(22) Filed: Jun. 4, 2025

Related U.S. Application Data
(60) Provisional application No. 63/677,076, filed on Jul. 30, 2024.

(51) Int. Cl. G06F 16/242

(52) U.S. Cl. CPC G06F 16/243

(57) ABSTRACT

Systems and methods for attribute extraction using generative models are disclosed. An attribute extraction request identifying item element data is received and at least one generative prompt is generated based on the attribute extraction request and the item element data. At least one generative model is configured based on the at least one generative prompt to extract a value of one or more attributes identified in the attribute extraction request and the value of the one or more attributes is extracted by the at least one generative model. A final attribute set including at least a portion of the value of the one or more attributes identified in the attribute extraction request is generated and an attribute-based automated process is implemented based on at least one attribute value in the final attribute set.

### CROSS-REFERENCE TO RELATED APPLICATIONS

This application claims priority to Provisional Application No. 63/677,076, filed on Jul. 30, 2024 and entitled “Systems and Methods for Attribute Extraction Using Generative Artificial Intelligence,” the contents of which are incorporated herein in their entirety.

### TECHNICAL FIELD

This application relates generally to machine learning, and more particularly, to attribute extraction for machine learning input using generative artificial intelligence (AI) processes.

### BACKGROUND

Some network platforms include collections, e.g., catalogs, of elements that are associated with the network platform. As one example, ecommerce network platforms include catalogs of item elements representative of items that may be viewed, purchased, and/or otherwise interacted with via the ecommerce network platform. In order to properly display, search, and process each item element in a collection or catalog, one or more attributes associated with each item element must be extracted from the data associated with and/or provided for the corresponding element.

Some current network platforms rely on user entry of attribute values for sets of attributes associated with item elements. Often, attribute values are omitted or incorrectly provided such that the attribute values are not included with or apparent from the corresponding item element data, such as a description, title, etc. Although machine learning has been applied by some current systems for attribute extraction, these systems utilize specific models for certain item element types. The specific models require increased resources, such as processing time and data, for training, refinement, and deployment that make such models slow to adapt to changing item elements and/or underlying data.

### SUMMARY

In various embodiments, a system is disclosed. The system includes a non-transitory memory and a processor communicatively coupled to the non-transitory memory. The processor is configured to read a set of instructions to receive an attribute extraction request identifying item element data, generate at least one generative prompt based on the attribute extraction request and the item element data, configure at least one generative model based on the at least one generative prompt to extract a value of one or more attributes identified in the attribute extraction request, extract, by the at least one generative model, the value of the one or more attributes, generate a final attribute set including at least a portion of the value of the one or more attributes identified in the attribute extraction request, and implement an attribute-based automated process based on at least one attribute value in the final attribute set.

In various embodiments, a computer-implemented method is disclosed. The computer-implemented method includes steps of receiving an attribute extraction request identifying item element data, generating at least one generative prompt based on the attribute extraction request and the item element data, configuring at least one generative model based on the at least one generative prompt to extract a value of one or more attributes identified in the attribute extraction request, extracting, by the at least one generative model, the value of the one or more attributes, generating a final attribute set including at least a portion of the value of the one or more attributes identified in the attribute extraction request, and implementing an attribute-based automated process based on at least one attribute value in the final attribute set.

In various embodiments, a non-transitory computer readable medium having instructions stored thereon is disclosed. The instructions, when executed by at least one processor, cause at least one device to perform operations including receiving an attribute extraction request identifying item element data, generating at least one generative prompt based on the attribute extraction request and the item element data, configuring at least large language model based on the at least one generative prompt to extract a value of one or more attributes identified in the attribute extraction request, extracting, by the at least one large language model, the value of the one or more attributes, generating a final attribute set including at least a portion of the value of the one or more attributes identified in the attribute extraction request, and implementing an attribute-based automated process based on at least one attribute value in the final attribute set.

### BRIEF DESCRIPTION OF THE DRAWINGS

The features and advantages of the embodiments described herein will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide generative AI-based attribute extraction for an item element generation pipeline of a network platform, in accordance with some embodiments;

FIG. 2 illustrates a computer system configured to implement one or more processes, in accordance with some embodiments;

FIG. 3 is a flowchart illustrating a generative AI-based attribute extraction method, in accordance with some embodiments;

FIG. 4 is a process flow illustrating various steps of the generative AI-based attribute extraction method of FIG. 3, in accordance with some embodiments; and

FIG. 5 illustrates a network application framework including an attribute extraction engine, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for attribute extraction in network platforms, such as in an item generation pipeline of a network platform. In various embodiments, item element data representative of an item is received by an item generation pipeline, for example, from a third party user device. A plurality of prompts are generated for a plurality of large language models (LLMs) and incorporate and/or reference the item element data received by the item generation pipeline. One or more of the plurality of prompts are provided to one or more of the LLMs. Each of the LLMs is configured, by the received one or more prompts, to perform attribute extraction with respect to the item element data. The plurality of LLMs are operated in an unsupervised process that performs attribute extraction via a single LLM call (e.g., based on a single instance of a prompt configuration). The extracted attributes may be provided to one or more additional processes.

In some embodiments, systems, and methods for generative AI-based attribute extraction includes one or more pre-generated LLMs. The LLMs may include one or more models, such as a large language model configured using any suitable corpus and/or training dataset and based on any suitable architecture. In various embodiments, the LLMs may include, but are not limited to, one or more general purpose LLMs (e.g., GPT 3.5, GPT 4, Llama, Llama 2, Bard), one or more domain-specific LLMs, one or more custom generated LLMs, and/or any other suitable LLM. In some embodiments, one or more LLMs may be trained and/or retrained during operation of the corresponding system, e.g., an item generation platform. In some embodiments, the plurality of LLMs include a hybrid model configured to utilize a subset of the plurality of LLMs based on one or more aspects of a received item element.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

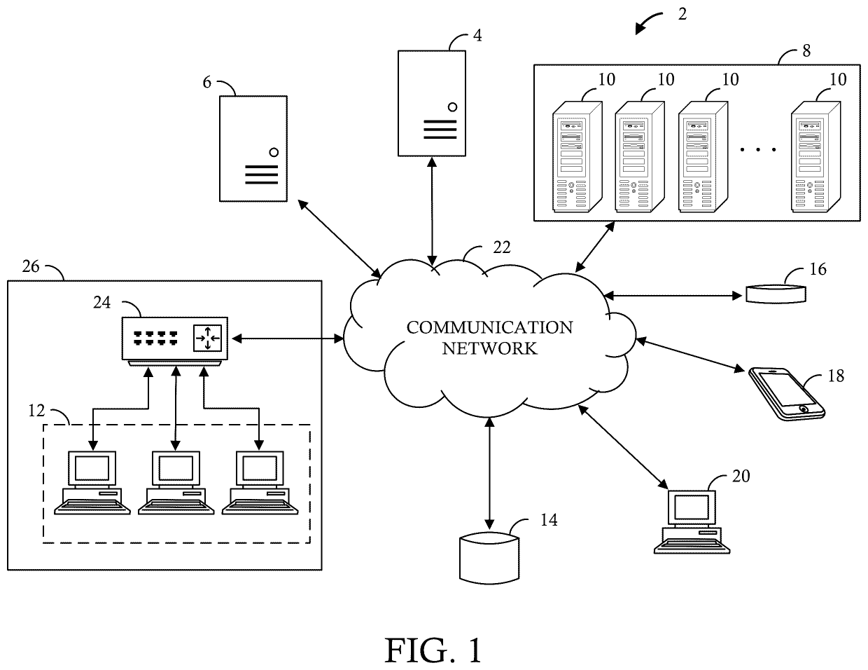

FIG. 1 illustrates a network environment 2 configured to provide generative AI-based attribute extraction for an item element generation pipeline of a network platform, in accordance with some embodiments. The network environment 2 includes a plurality of devices or systems configured to communicate over one or more network channels, illustrated as a network cloud 22. For example, in various embodiments, the network environment 2 may include, but is not limited to, an attribute extraction computing device 4, a web server 6, a cloud-based engine 8 including one or more processing devices 10, a database 14, and/or one or more user computing devices 16, 18, 20 operatively coupled over the network 22. The attribute extraction computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the attribute extraction computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the attribute extraction computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the attribute extraction computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the attribute extraction computing device 4, for example. The workstation(s) 12 may communicate with the attribute extraction computing device 4 over the communication network 22. The workstation(s) 12 may send data to, and receive data from, the attribute extraction computing device 4. For example, the workstation(s) 12 may transmit data related to tracked operations performed at the physical location 26 to the attribute extraction computing device 4.

Although FIG. 1 illustrates three user computing devices 16, 18, 20, the network environment 2 may include any number of user computing devices 16, 18, 20. Similarly, the network environment 2 may include any number of the attribute extraction computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the attribute extraction computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, upload item element data to one or more databases and/or catalogs, initiate one or more operations based on extracted attributes, etc. The website may capture these activities as user session data, and transmit the user session data to the attribute extraction computing device 4 over the communication network 22. The website may also allow the user to interact with one or more of interface elements to perform specific operations, such as selecting one or more items for further processing.

In some embodiments, the attribute extraction computing device 4 may execute one or more models, processes, or algorithms, such as a prompt generation model and/or a plurality of LLMs, to extract attributes from received item element data. The attribute extraction computing device 4 may transmit extracted attributes to the web server 6 over the communication network 22, and the web server 6 may generate item elements within one or more databases and/or catalogs containing the extracted attributes and/or perform one or more operations based on the extracted attributes.

The attribute extraction computing device 4 is further operable to communicate with the database 14 over the communication network 22. For example, the attribute extraction computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the attribute extraction computing device 4, in some embodiments, the database 14 may be a local storage device, such as a hard drive, a non-volatile memory, or a USB stick. The attribute extraction computing device 4 may store interaction data received from the web server 6 in the database 14. The attribute extraction computing device 4 may also receive from the web server 6 user session data identifying events associated with browsing sessions, and may store the user session data in the database 14.

In some embodiments, the attribute extraction computing device 4 assigns one or more models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, the attribute extraction computing device 4 may generate one or more sets of attributes for one or more item elements to be added to and/or stored in a network catalog.

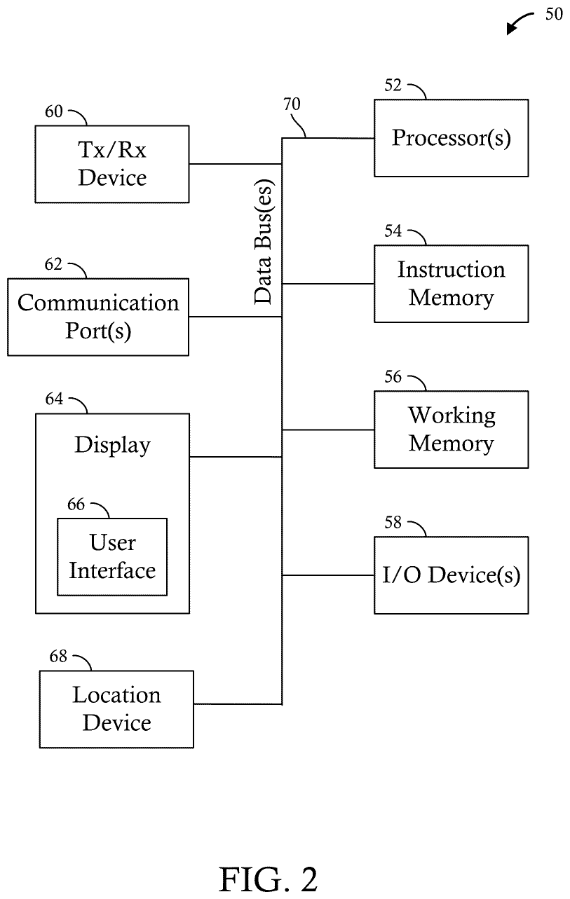

FIG. 2 illustrates a block diagram of a computing device 50, in accordance with some embodiments. In some embodiments, each of the attribute extraction computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple MacOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for generative AI-based attribute extraction, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with extracted attributes. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

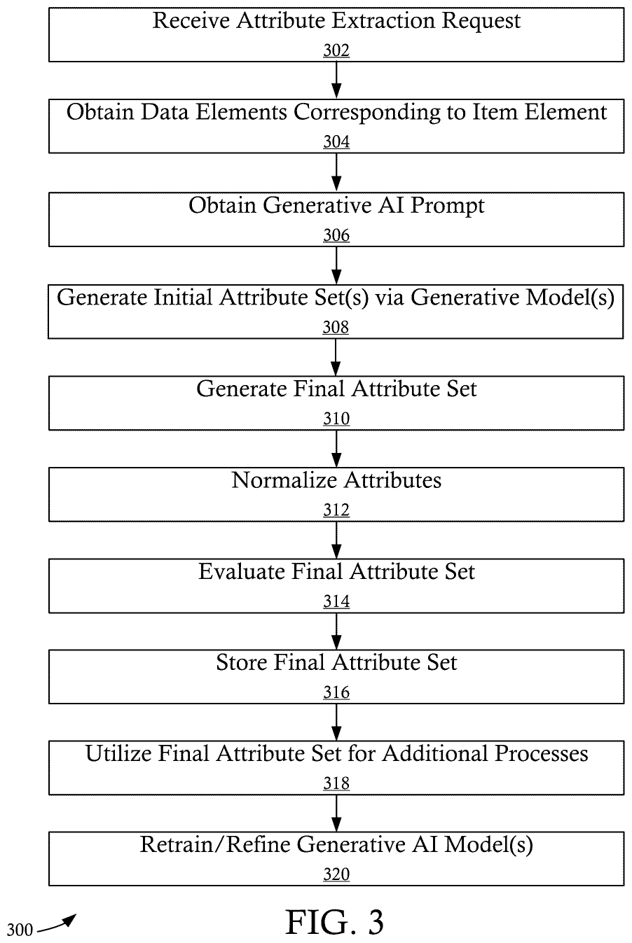

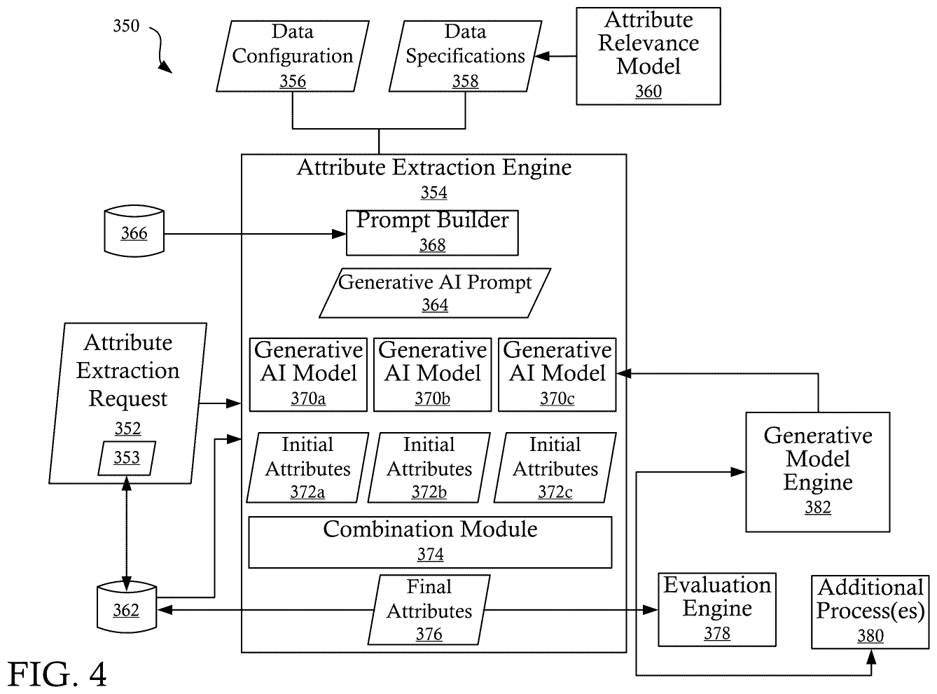

FIG. 3 is a flowchart illustrating a generative AI-based attribute extraction method 300, in accordance with some embodiments. FIG. 4 is a process flow 350 illustrating various steps of the generative AI-based attribute extraction method 300, in accordance with some embodiments. Although embodiments are discussed herein including application of certain steps and/or processes, it will be appreciated that various elements of the generative AI-based attribute extraction method 300 may be performed in various orders and/or performed by additional and/or alternative processes or system elements as those disclosed herein.

At step 302, an attribute extraction request 352 is received and/or generated. The attribute extraction request 352 is representative of a request by one or more processes to perform attribute extraction for one or more item elements. The attribute extraction request 352 may include data representative of and/or identifying data elements associated with an item element corresponding to the data extraction request 352. For example, the attribute extraction request 352 may include item element data 353 representative of and/or identifying an item element data structure including one or more data elements, such as a title, description, etc., that may be utilized for attribute extraction. The attribute extraction request 352 may be generated by a first process, such as a module or engine implemented in conjunction with an item element generation pipeline, and provided to a second module or engine, such as an attribute extraction engine 354. The attribute extraction request 352 may additionally and/or alternatively be generated internally by a single process, such as an attribute extraction engine 354, configured to operate on a provided dataset, such as, for example, an item catalog associated with a network platform.

In some embodiments, the attribute extraction engine 354 receives one or more data configurations 356 and/or data specifications 358 for defining attributes to be extracted from corresponding item element data 353. For example, in the illustrated embodiment, the attribute extraction engine 354 receives attribute model configuration data 356 defining attributes to be extracted from the corresponding item element data and attribute specifications 358 indicating a form of each attribute, such as a closed list attribute (e.g., an attribute having a predefined set of acceptable values for the attribute), an open list attribute (e.g., an attribute that has no or substantially no limitations regarding the value of the attribute for a corresponding item element), a multi-select attribute, a unit of measure attribute etc. The attribute specifications 358 may include specific definitions for certain attributes, such as defining the set of acceptable values for a closed list attribute (e.g., where the attribute is “age group,” acceptable values may include “baby,” “toddler,” “child,” “adult,” “senior,” etc.). The attribute specifications 358 may additionally or alternatively include specific definitions for a unit of measure for a unit of measure attribute (e.g., defining a “megabyte (MB)” unit of measure for a “RAM” attribute, a “centimeter” unit of measure for a “size” attribute, etc.). In some embodiments, the attribute specifications 358 include an attribute relevance score configured to indicate a relevance (e.g., priority) of a corresponding attribute included in the attribute specifications 358. The attribute relevance score may be determined by an attribute relevance model 360.

At step 304, one or more data elements corresponding to the item element data 353 are obtained. As discussed above, the item element data 353 may include data defining an item element for attribute extraction and/or may include a reference (e.g., a pointer) to a data store containing the corresponding data elements (e.g., an item element data structure). For example, in one non-limiting example, item element data 353 may include a reference to one or more item element data structures stored in an item catalog 362 associated with a network platform and the attribute extraction engine 354 may obtain the corresponding item element data from the item datastore 362 (e.g., item catalog) in response to receiving the attribute extraction request 352. Although embodiments are discussed herein including attribute extraction for a single item element, it will be appreciated the attribute extraction request 352 may include a bulk attribute extraction request configured to cause the generative AI-based attribute extraction method 300 to be executed on a data store of item elements to cause attributes of each item element in the data store to be extracted and, optionally, stored with the corresponding item element and/or in the corresponding item element data structure.

At step 306, a generative AI prompt 364 is obtained. The generative AI prompt 364 includes a prompt, e.g., an input, such as a textual input, that configures a target model, such as an LLM, to generate an intended output. The generative AI prompt 364 may include configuration elements, such as textual configurations or definitions, that configure a corresponding generative model for a specific task, such as attribute extraction. The generative AI prompt 364 may be obtained from a prompt data store 366 and/or generated by any suitable prompt generation process, such as, for example, a prompt generation process implemented by a prompt builder 368.

In some embodiments, a generative AI prompt 364 is generated based on one or more templates. For example, in some embodiments, a prompt builder 368 may be configured to generate template prompts for each attribute defined by an attribute extraction model 356 and/or an attribute specification 358. When item element data is received for attribute extraction, the attribute extraction engine 354 may identify the attributes for a classifier (e.g., type) associated with the item element data and obtain predefined attribute extraction templates for one or more attributes associated with the classifier. As another example, in some embodiments, one or more attribute types may have a corresponding prompt template that may be modified and/or completed by the prompt builder 368 based on corresponding attribute-specific requirements and/or the item element data of a corresponding item element.

In some embodiments, one or more prompt templates are selected by applying a rules engine to the corresponding item element data based on the attribute specification data 358. For example, in some embodiments, one or more parameters of the item element data, such as a an item element type, determines the corresponding attributes of that item element. The one or more parameters and the attribute specification data 358 may be utilized to select one or more prompt templates corresponding to the attributes to be extracted and/or the data expected to be included with the item element data.

In some embodiments, the generative AI prompt 364 includes a configuration portion including one or more configurations for the corresponding model. For example, a configuration portion of a generative AI prompt 364 may be in the form of:
You are an experienced Category Manager leading the <Product Type> department within [Store] and you are able to do attribute extraction easily from the product description. Given the list of attributes <Attribute1, Attribute2, Attribute3, etc.> and the target description <target data source>, extract the attributes in [predetermined format] and return the extracted “value” and the “snippet” from the target description that you used for extracting the value. Your answer must always be in a valid and parsable [format] with the key extracted_attributes. Please carefully and strictly follow the extraction rule for attributes present in the Rules section below.

Rules
[
<Atrribute1 Rule>
<Attribute2 Rule>
<Attribute3 Rule>
]

It will be appreciated that the foregoing prompt is provided only as an example and alternative prompts may be used for the same and/or different generative models, as discussed in greater detail below. For example, in various embodiments, a generative AI prompt 364 may include one or more of a target data source, an item element type, a list of attributes, acceptable values for closed list attributes, acceptable units of measure for UoM attributes, instructions to extract and/or format attributes, etc.

In some embodiments, at least a portion of the generative AI prompt 364 is determined based on a type of attribute associated with the prompt. For example, a prompt including an open list attribute may include an attribute definition in the form of:
Attribute Name: Extract from <target data source>
   The target data source may include a portion of item element data associated with an item element, such as, for example, a title, item description, etc. As another example, a prompt including a closed list attribute may include a definition in the form of:
Attribute Name: Extract from <target data source> enclosed and transform the value you are extraction to one of the semantically most similar values present here: [Predefined Attribute Values]. Use the highest cosine similarity score to determine the match. If the cosine similarity score is less than threshold_value, please assign null
   The predefined attribute values include a discrete number of predefined values for an attribute, e.g., Attribute_Value_1, Attribute_Value_2, etc. The threshold_value may include any suitable threshold, such as, for example, 0.1, 0.15 0.2, 0.25 0.3, etc. As yet another example, a prompt including a unit of measure attribute may include a definition in the form of:
Attribute Name: Extract the value and unit of measurement from <target data source> only if it has one of the following units of measurement: [Acceptable Units].
   The acceptable units may define a set of related units, such as a set of measurements units (e.g., cm, mm, in, ft, etc. that may each identify the corresponding attribute in the target data source. In some embodiments, an additional definition, such as:
If the sizes specified are in the format [format], you must consider it as [specific dimensions].
   may be applied to indicate an expected order of values, for example specifying that values provided as L*W*H should be interpreted as length*width*height. Although specific embodiments are discussed herein, it will be appreciated that any suitable attribute definitions may be used based on the attribute type and/or target values of the attribute.

In some embodiments, a generative AI prompt 364 includes a plurality of attribute definitions for each of the attributes to be extracted by the corresponding model. For example, a generative AI prompt 364 generated for a first item element type (e.g., books) may include a plurality of attribute definitions for each potential attribute associated with the element type, e.g., associated with a book. The plurality of attribute definitions may include a mix of different attribute types, e.g., a mix of open list, closed list, unit of measure, etc.

At step 308, the one or more generative AI prompts are provided to a plurality of generative models 370a-370c (collectively “generative models 370”) to generate a corresponding initial attribute set 372a-372c (collectively “initial attribute sets 372”). The generative models 370 may include a plurality of generative models, such as LLMs, each having a different architecture and/or trained structure. For example, in some embodiments, the generative models 370 may include a plurality of LLMs having one or more known frameworks, such as, for example, one or more GPT 4 models, one or more GPT 3.5 models, one or more Palm/Palm2 models, one or more Llama/Llama2 models, etc.

Each of the generative models 370 is configured to receive a corresponding generative AI prompt 364 and generate a corresponding initial attribute set 372a-372c. Although the illustrated embodiment includes a single generative AI prompt 364 being provided to each of the generative models 370, it will be appreciated that the prompt builder 368 may be configured to generate a plurality of generative AI prompts 364. At least two of the generative models 370 may receive different generative AI prompts 364. In some embodiments, each of the generative models 370 receives a model-specific generative AI prompt.

The initial attribute set 372a-372c generated by any one of the generative models 370 may be partially and/or entirely overlapping with the initial attribute set 372a-372c generated by any one or more of the other generative models 370 and/or may be exclusive with respect to the initial attribute set 372a-372c generated by any one of the other generative models.

At step 310, the attribute values in each of the initial attribute sets 372 may be combined to generate a final attribute set 376. The initial attribute sets 372 may be combined using any suitable process and/or module, such as a combination module 374. The combination module 374 may be configured to apply one or more combinatorial rules and/or processes to select, rank, combine, and/or otherwise filter the initial attribute sets 372 to generate the final attribute set 376. For example, in embodiments including exclusive initial attribute sets 372a-372c, the final attribute set 376 may be generated by aggregating the initial attribute sets 372 into a single set. As another example, in embodiments including at least partially overlapping initial attribute sets 372a-372c, the final attribute set 376 may be generated by aggregating non-overlapping attributes and implementing a combination process for individual overlapping extracted attribute values.

The combination module 374 may be configured to utilize any suitable combinatorial process for determining a final attribute value for attributes having multiple values in the initial attribute sets 372. For example, in some embodiments, each of the generative models 370 may generate a confidence score for an extracted attribute and the value of an extracted attribute in the final attribute set 376 may correspond to the initial attribute value (e.g., the attribute value in the initial attribute sets 372) having the highest corresponding confidence value. As another example, in some embodiments, the value of an attribute in the final attribute set 376 may be selected based on corresponding model confidence values for a given attribute, e.g., a first model may have a higher accuracy or confidence for extracting a first type of attribute and a second model may have a higher accuracy or confidence for extracting a second type of attribute. As yet another example, in some embodiments, the value of an attribute in the final attribute set 376 may be an average, mean, median, weighted average, and/or any other suitable combination of two or more values for the corresponding attribute in the initial attribute sets 372.

At step 312, one or more of the attribute values in the initial attribute sets 372a-372c and/or in the final attribute set 376 are normalized. For example, in some embodiments, attribute values in the initial attribute sets 372 may be normalized prior to being combined into the final attribute set 376. It will be appreciated that, in such embodiments, step 312 may occur prior to step 310 (e.g., just after and/or in conjunction with portions of step 308). As another example, in some embodiments, one or more attribute values in the final attribute set 376 may be normalized after generation of the final attribute set 376. Normalization may include any suitable normalization process, such as, for example, a transformation process from a first unit to a second unit (e.g., a unit of measure extracted in a first unit definition (e.g., “inches”) may be converted to a second unit definition required by the attribute specifications 358 (e.g., “in”).

At optional step 314, the final attribute set 376 may be evaluated. The final attribute set may be evaluated by any suitable process and/or module, such as an attribute evaluation engine 378. For example, an attribute evaluation engine 378 may be configured to evaluate each of the attributes values in the final attribute set 376 according to one or more criteria to determine accuracy, precision, and/or any other evaluation criteria for the extracted attributes. In some embodiments, the attribute evaluation engine 378 implements an automated process configured to apply one or more evaluation tests and/or evaluation rules. In some embodiments, the attribute evaluation engine 378 includes one or more of the generative AI models 370 utilized during the attribute extraction process at steps 308-312 re-configured to perform attribute evaluation. In some embodiments, the attribute evaluation engine 378 generates an item enrichment score representative of an improvement to the attribute data associated with a given item element based on the attributes extracted by the item extraction process. The score may be calculated using any suitable metrics, such as, for example, number of attributes completed and/or confirmed by the extraction process, accuracy of the extracted attributes, priority of the extracted attributes, etc.

At step 316, the final attribute set 376 is applied to and/or stored in conjunction with an item element data structure representative of the item element data 353. The item element data structure and the corresponding final attribute set 376 may be stored in any suitable data storage mechanism, such as, for example, a data store 362 representative of a network catalog. The final attribute set 376 may be stored as part of and/or referenced to an item element data structure within a data store and/or may be separately stored from the item element data structure, such as in a result store (not shown).

At step 318, a final set of attributes stored in conjunction with and/or in reference to an item element may be used for one or more additional processes. For example, in some embodiments, one or more of the attributes may be provided to an interface generation process for display in conjunction with interface elements representative of and/or encompassing the item element. As another example, in some embodiments, one or more of the attributes may be utilized for one or more operations based on and/or directed to the data store of item elements, such as a search of the item elements, complementary item element identification, etc.

At optional step 320, one or more of the initial sets of attributes and/or the final set of attributes may be utilized to refine and/or retrain one or more of the generative models 370. For example, an initial set of attributes generated by a first generative model 370a is utilized as an input to a process configured to refine a third generative model 370c. In some embodiments, the output of one of the generative models 370 may be provided as an input, alone or in conjunction with additional inputs, to a process to refine the same one of the generative models 370. For example, in some embodiments, the output of the third generative model 370c and an item enrichment score for a corresponding item element may be provided as inputs to refine and/or retrain the third generative model 370c.

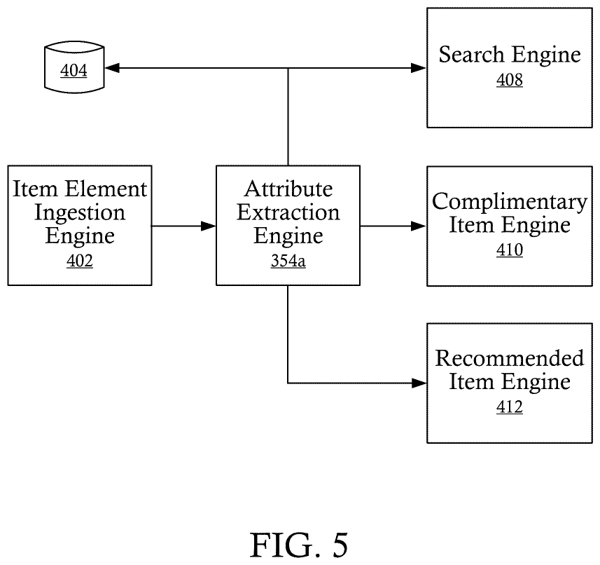

FIG. 5 illustrates a network application framework 400 including an attribute extraction engine 354a, in accordance with some embodiments. Although embodiments are discussed herein including the network application framework 400 and/or components thereof, it will be appreciated that the disclosed systems and methods may be applied to any suitable network application framework. The network application framework 400 includes an item element ingestion engine 402 and an item element data store 404. The item element ingestion engine 402 is configured to receive item element data from one or more sources and generate item element data structures for inclusion in the item element data store 404. The item element storage 404 includes any suitable structure configured to store the item element data structures.

The network application framework 400 includes an attribute extraction engine 354a configured to extract attributes from one or data elements associated with an item element according to the generative AI based attribute extraction method 300 discussed above with respect to FIGS. 3-4. The attribute extraction engine 354a may be in data communication with the item element ingestion engine 402 and/or the item element data store 404. For example, in some embodiments, when a new item element is generated by the item element ingestion engine 402, it may be provided to the attribute extraction engine 354a to extract one or more attributes for storage in conjunction with the generated item element data structure. As another example, in some embodiments, the attribute extraction engine 354a is configured to obtain existing item element data structures from the item element data store 404 and augment or enrich the existing item element data structures with additionally and/or alternatively extracted attributes.

In some embodiments, the attribute extraction engine 354a performs attribute extraction according to the method 300 discussed above. Item element data structures including extracted attributes may be stored in the item element data store 404 for additional tasks. For example, as illustrated in FIG. 5, a network application framework may include additional engines and/or modules, such as a search engine 408, a complimentary item engine 410, a recommended item engine 412, etc. Each of the additional engines 408-412 may be configured to utilize extracted attributes stored in conjunction with item element data structures. For example, in some embodiments, a search engine 408 may be configured to search attribute values based on a received query. As another example, a complimentary item engine 410 and/or a recommended item engine 412 may be configured to utilize one or more attributes to identify complimentary/recommended items. In some embodiments, the attribute values may be converted into embeddings for use in one or more additionally defined machine learning models. It will be appreciated that any suitable engine may utilize the attribute values extracted and stored in conjunction with the corresponding item element data structures.

It will be appreciated that attribute extraction as disclosed herein, particularly on large datasets intended to be used with network applications having large catalogs of items, is only possible with the aid of computer-assisted machine-learning algorithms and techniques, such as generative models and/or prompt building processes described herein. In some embodiments, machine learning processes including generative AI processes are used to perform operations that cannot practically be performed by a human, either mentally or with assistance, such as automated attribute extraction as discussed above.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive an attribute extraction request identifying item element data;
generate at least one generative prompt based on the attribute extraction request and the item element data;
configure at least one generative model based on the at least one generative prompt to extract a value of one or more attributes identified in the attribute extraction request;
extract, by the at least one generative model, the value of the one or more attributes;
generate a final attribute set including at least a portion of the value of the one or more attributes identified in the attribute extraction request; and
implement an attribute-based automated process based on at least one attribute value in the final attribute set.

2. The system of claim 1, wherein the processor is configured to read the set of instructions to:
determine a classifier associated with the item element data;
receive an attribute extraction template based on the determination; and
generate the at least one generative prompt based on the attribute extraction template.

3. The system of claim 1, wherein the processor is configured to read the set of instructions to receive attribute model configuration data, and determine the one or more attributes to be extracted from the item element data based on the attribute model configuration data.

4. The system of claim 1, wherein the processor is configured to read the instructions to generate the at least one generative prompt to comprise one or more configurations for the at least one generative model, and configure the at least one generative model based on the one or more configurations.

5. The system of claim 1, wherein the processor is configured to read the set of instructions to determine at least a portion of the at least one generative prompt based on an associated type of attribute.

6. The system of claim 1, wherein the processor is configured to read the instructions to generate the at least one generative prompt to comprise a plurality of attribute definitions for each of the one or more attributes, and configure the at least one generative model based on the plurality of attribute definitions.

7. The system of claim 1, wherein the at least one generative prompt comprises a first generative prompt and a second generative prompt, and the at least one generative model comprises a first generative model and a second generative model, wherein the processor is configured to read the instructions to:
configure the first generative model based on the first generative prompt;
configure the second generative model based on the second generative prompt;
extract, by the first generative model, at least a first portion of the value of the one or more attributes;
extract, by the second generative model, at least a second portion of the value of the one or more attributes; and
generate the final attribute set based on the first portion of the value of the one or more attributes and the second portion of the value of the one or more attributes.

8. The system of claim 1, wherein the processor is configured to read the instructions to extract, by the at least one generative model, a confidence value associated with each of the one or more attributes, and generate the final attribute set to include, for each of the one or more attributes, the value associated with a highest corresponding confidence value.

9. The system of claim 1, wherein the interface generation process causes a display of the at least one attribute value in the final attribute set in conjunction with interface elements associated with the item element data.

10. A computer-implemented method, comprising:
receiving an attribute extraction request identifying item element data;
generating at least one generative prompt based on the attribute extraction request and the item element data;
configuring at least one generative model based on the at least one generative prompt to extract a value of one or more attributes identified in the attribute extraction request;
extracting, by the at least one generative model, the value of the one or more attributes;
generating a final attribute set including at least a portion of the value of the one or more attributes identified in the attribute extraction request; and
implementing an attribute-based automated process based on at least one attribute value in the final attribute set.

11. The method of claim 10, comprising:
determining a classifier associated with the item element data;
receiving an attribute extraction template based on the determination; and
generating the at least one generative prompt based on the attribute extraction template.

12. The method of claim 10, comprising receiving attribute model configuration data, and determining the one or more attributes to be extracted from the item element data based on the attribute model configuration data.

13. The method of claim 10, comprising generating the at least one generative prompt to comprise one or more configurations for the at least one generative model, and configuring the at least one generative model based on the one or more configurations.

14. The method of claim 10, comprising determining at least a portion of the at least one generative prompt based on an associated type of attribute.

15. The method of claim 10, comprising generating the at least one generative prompt to comprise a plurality of attribute definitions for each of the one or more attributes, and configuring the at least one generative model based on the plurality of attribute definitions.

16. A non-transitory computer readable medium having instructions stored thereon, wherein the instructions, when executed by at least one processor, cause at least one device to perform operations comprising:
receiving an attribute extraction request identifying item element data;
generating at least one generative prompt based on the attribute extraction request and the item element data;
configuring at least large language model based on the at least one generative prompt to extract a value of one or more attributes identified in the attribute extraction request;
extracting, by the at least one large language model, the value of the one or more attributes;
generating a final attribute set including at least a portion of the value of the one or more attributes identified in the attribute extraction request; and
implementing an attribute-based automated process based on at least one attribute value in the final attribute set.

17. The non-transitory computer readable medium of claim 16, wherein the instructions, when executed by the at least one processor, cause the at least one device to perform operations comprising:
determining a classifier associated with the item element data;
receiving an attribute extraction template based on the determination; and
generating the at least one generative prompt based on the attribute extraction template.

18. The non-transitory computer readable medium of claim 16, wherein the instructions, when executed by the at least one processor, cause the at least one device to perform operations comprising receiving attribute model configuration data, and determining the one or more attributes to be extracted from the item element data based on the attribute model configuration data.

19. The non-transitory computer readable medium of claim 16, wherein the instructions, when executed by the at least one processor, cause the at least one device to perform operations comprising generating the at least one generative prompt to comprise one or more configurations for the at least one generative model, and configuring the at least one generative model based on the one or more configurations.

20. The non-transitory computer readable medium of claim 16, wherein the instructions, when executed by the at least one processor, cause the at least one device to perform operations comprising determining at least a portion of the at least one generative prompt based on an associated type of attribute.
